(19) United States
(12) Patent Application Publication
(10) Pub. No.: US 2004/0117298 A1
(43) Pub. Date: Jun. 17, 2004

(54) Method and system for initiating a chargeback

(75) Inventors: Kenneth Algiene, Littleton, CO (US); Henry M. Abelman, Roswell, GA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/321,886

(22) Filed: Dec. 17, 2002

(51) Int. Cl. G06F 17/60

(52) U.S. Cl. 705/39; 705/40

(57) ABSTRACT

A system for initiating a chargeback request by a user. A system can be provided according to one embodiment of the invention that allows a user to submit a chargeback request via a network connection. A user interface can be provided which allows a user to submit such a chargeback request via a computer network system. Furthermore, according to another embodiment of the invention, a billing statement can be provided on-line which allows a user to submit a chargeback request by highlighting a specific transaction shown in the billing statement.

### CROSS-REFERENCES TO RELATED APPLICATIONS NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE.

This invention relates generally to disputing a financial transaction. More particularly, embodiments of the invention relate to initiating a chargeback process.

### BACKGROUND

A system has developed for processing transactions engaged in between consumers and merchants. A consumer charge card, for example, can be utilized by the consumer to pay for goods or services provided by a merchant. The merchant then forwards the transaction information to its acquiring bank. The acquiring bank settles the payment with the bank that issued the card to the consumer. Sometimes, the consumer's account will be charged an erroneous charge. Thus, a process has developed to allow the consumer to dispute charges. Namely, the user is generally provided a set period of time, such as 45 days from when the transaction is charged against the consumer's account to contest the charge. Such a contested charge is referred to as a “chargeback”. The chargeback is then processed by the issuing bank and acquiring bank to determine whether the charge was mistakenly applied or is indeed a valid charge. This resolution process can be handled by credit processing companies such as First Data Corporation.

In the past, the process of submitting a chargeback request has been an inconvenient one requiring the consumer to not only obtain a form for submission to the issuing bank, but also, requiring the consumer to obtain and submit the form within the allotted time period. As a result of this inconvenient process, consumers sometimes missed the deadline for disputing a charge. Furthermore, some consumers simply decide not to dispute a charge given the time involvement in obtaining and submitting the necessary papers. Thus, this results in a less efficient credit system.

### SUMMARY OF THE INVENTION

According to various embodiments of the invention, a system is provided to facilitate the disputing of a credit charge. For example, a method of disputing a credit charge can be implemented by providing a user interface for use by a user in disputing a credit charge which has been charged to an account of the user; providing access to this interface by the user via a network connection; receiving an input via this user interface from the user who is disputing the credit charge; and initiating a chargeback of the disputed credit charge.

According to another embodiment of the invention, a system is provided which allows a user to access on-line the user's billing statement. The user can then indicate the disputed transaction on the billing statement and automatically submit a chargeback request. In addition, the billing statement can be recalculated to obtain a new balance due which does not include the disputed credit charge.

### BRIEF DESCRIPTION OF THE DRAWINGS

FIG. 1 illustrates a flowchart demonstrating a method according to one embodiment of the invention for providing a user interface for allowing a user to dispute a credit charge.

FIGS. 2a and 2b illustrate a flowchart demonstrating a method according to one embodiment of the invention for providing a billing statement accessible by a user which facilitates the user automatically submitting a chargeback request.

FIG. 3 illustrates a flowchart demonstrating a method according to one embodiment of the invention for providing a user interface that allows the user to check on the progression of a disputed credit charge.

FIG. 4 illustrates a system according to one embodiment of the invention in which users and merchants can process disputed financial transactions.

FIG. 5 illustrates a user interface according to one embodiment of the invention for allowing a user to access a billing statement and submit a chargeback request.

FIG. 6 illustrates a system for implementing devices shown in FIGS. 5 and 4.

### DETAILED DESCRIPTION

In processing disputed credit transactions, a time lag in disputing a charge is often encountered due to the infrequency with which consumers need to dispute transactions. Typically, disputed charges occur so infrequently for a consumer that the consumer is not familiar with the process of disputing the transaction. Furthermore, existing systems require a written submission be made by a user to contest a charge. This requires that a user obtain the necessary paperwork to make a submission. Thus, a substantial time lag often exists between the consumer discovering an inaccurate charge and actually requesting that the charge be evaluated.

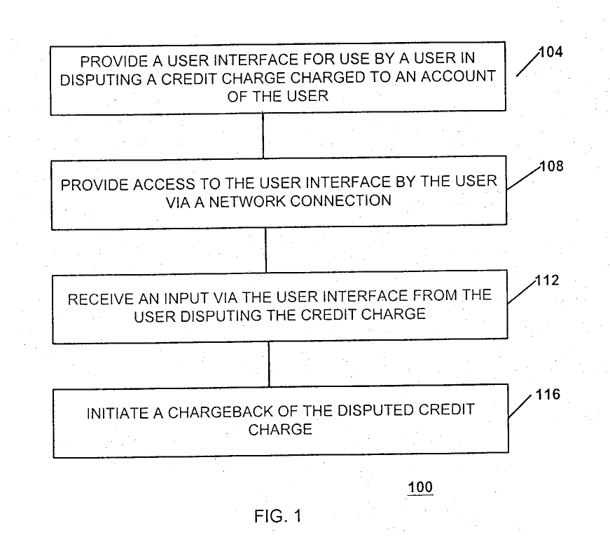

Rules have been established by the various banks so as not to permit users to dispute a charge after a given time period from when they receive their bill. Thus, the user who is unfamiliar with the process of disputing a charge could be inadvertently barred from disputing the charge if he or she waits too long to initiate the dispute. According to one embodiment of the invention, a user can be supplied with a tool to greatly facilitate the dispute process. Namely, a user can be provided with a user interface to initiate the dispute via a network system. For example, a user can be provided a user interface via a website, such as the issuing bank's website to submit a chargeback request. FIG. 1 illustrates a flowchart for implementing such an embodiment of the invention.

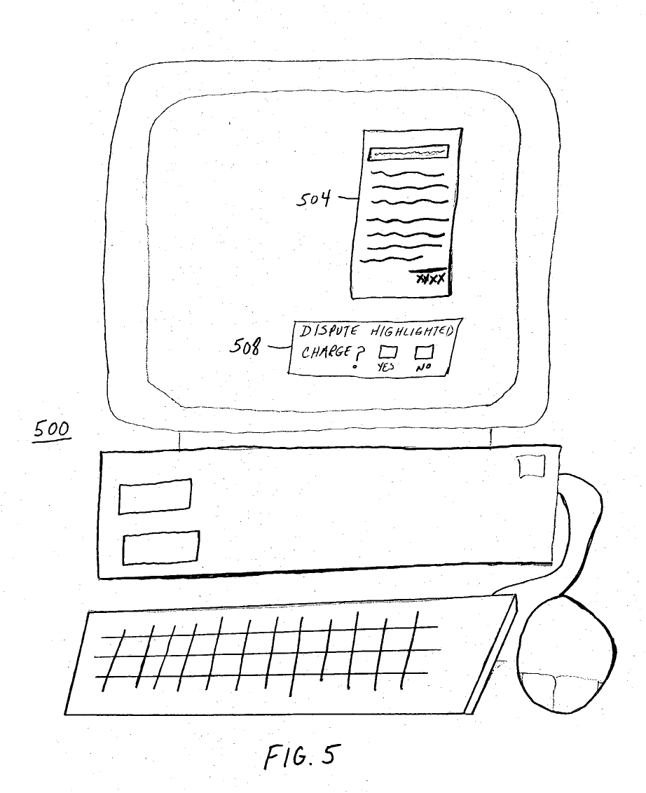

According to flowchart 100 of FIG. 1, a user is provided with a user interface (such as that shown in FIG. 5) for use by the user in disputing a credit charge charged to an account of the user, as shown in block 104. The user is provided access to this interface via a network connection as shown in block 108. Such a network connection could take a variety of forms. For example, the user can be provided with a purely telephonic connection which allows the user to enter the particulars of the disputed charge via a touch tone phone. Thus, the user enters the identifying number for a charge, the charge amount, as well as the user's own identification information. In this manner, the user disputes the charge via a telephone network.

Alternatively, the user can be provided with a user interface via a website of the user's bank. Thus, the user visits the website and accesses an account specific to the individual user. The user then obtains the billing statement for the desired month and views the details of the user's account. If a disputed charge is discovered by the user, the user then submits a chargeback request while on-line. Such a user interface can be provided from the main website of the bank. Similarly, it can be provided by a credit processing service, such as First Data Corporation. In this manner, the credit processing system can receive from the user an input via the user interface which indicates that the credit charge is being disputed as shown in block 112. Once such a chargeback indication is received from a user, chargeback of the disputed credit charge can be initiated by the processing system as indicated in block 116.

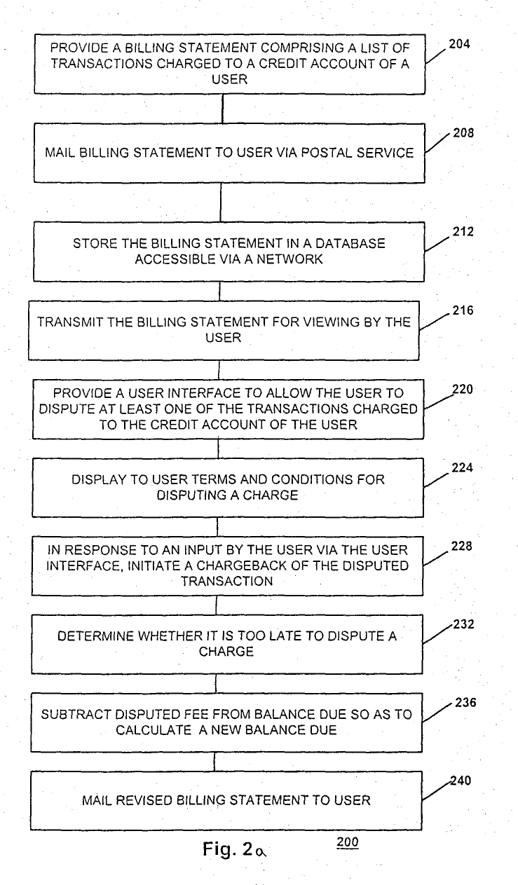

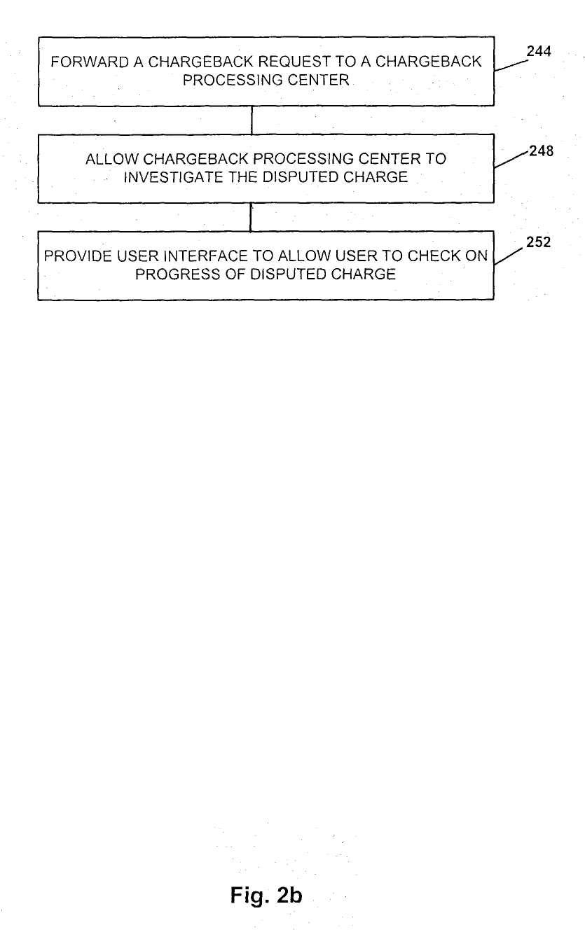

FIGS. 2a and 2b illustrate a flowchart 200 demonstrating a method according to another embodiment of the invention. According to flowchart 200 a billing statement is provided in block 204 comprised of a list of transactions charged to a credit account of a user. This billing statement can be mailed via the postal service (or even via email) to a user as shown in block 208. The billing statement is also stored in a database which is accessible via a network connection as shown in block 212. The user can access the billing statement by accessing the database copy via the network. Thus, the billing statement is transmitted to the user for viewing as shown in block 216.

A user interface is provided to allow the user to view the billing statement. For example, according to one example, the billing statement showing all transactions for a billing period would be displayed on the user's computer. The balance due would also be shown. The user could then highlight a specific transaction to invoke a request to dispute that particular transaction. Thus, as shown in block 220, a user interface can be provided to allow the user to dispute at least one of the transactions charged to the credit account of the user. In addition, the terms and conditions for disputing a charge can be displayed to the user, as shown in block 224. When the user decides to dispute a charge, the user can submit the dispute via the user interface. In this manner, a chargeback can be initiated in response to receipt of the input by the user as shown in block 228. Upon receipt of the disputed charge indication from the user, the credit processing system can determine whether too much time has elapsed under the rules of the system so as to determine whether it is too late for the user to dispute a charge. This is shown in block 232. If it is not too late for a user to dispute a charge, the disputed charge can be subtracted from the balance due so as to calculate a new balance due for the user's account as shown in block 236. A revised billing statement can then be mailed to the user as shown in block 240. Furthermore, a billing statement can also be emailed to the user. Thus, this immediately accessible chargeback process can be implemented so as to achieve quite a dramatic improvement in initiating the chargeback process as well as accommodating consumers who do not wish to pay for a charge they do not believe they owe.

Once the chargeback indication is received from a user and is determined to fall within the approved time period, a chargeback request can be submitted to a chargeback processing center as shown in block 224. One example of a chargeback processing center is First Data Merchant Services of Hagerstown, Md. The chargeback processing center can then investigate the disputed charge as shown in block 248. This typically entails the chargeback processing center submitting the chargeback request to the acquiring bank and requesting further information from the acquiring bank or merchant of the acquiring bank. The merchant can then provide supporting documentation that shows that the user did indeed conduct the transaction with the merchant. Alternatively, if an error is discovered, then the processing center can determine that the disputed charge was indeed a mistake and correct the account of the user.

The processing of a dispute can entail a series of requests for documentation from the various parties involved in the dispute. Thus, according to one embodiment of the invention, the user can be provided access to trace the progress of the disputed credit charge. Thus, as shown in block 252 a user interface can be provided to allow the user to check on the progress of the disputed charge.

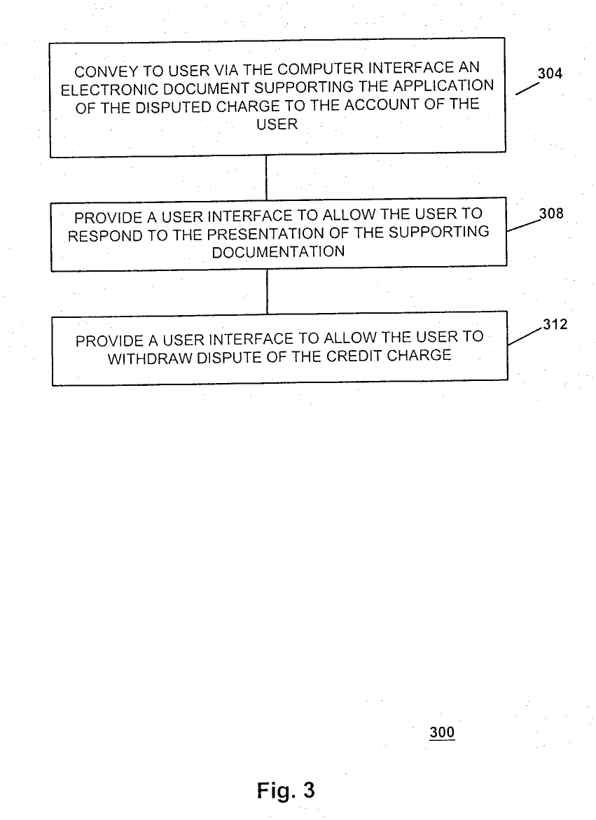

FIG. 3 illustrates a method of providing further interaction by the user in the dispute process. As shown in block 304 of flowchart 300, an electronic document can be conveyed to the user via the computer interface so as to support the application of the charge to the account of the user. For example, if a merchant provides a sales receipt showing the user's signature, the merchant can electronically submit the sales receipt by scanning it and transmitting it to the processing center. An auditor at the processing center can then forward (e.g., via email) the electronic image to the user for the user's review. Similarly, the electronic image can be stored in a database which is accessible by the user. Thus, the user could call up a file history for a disputed charge and review documents provided as part of that file. All of this can be provided through a user interface which allows the user to interact with the database or the processing center. Similarly, the user interface could be provided through the user's bank's computer system. Block 308 shows that the user interface is also provided to allow the user to respond to the supporting documentation. Thus, if a user is provided with a signed sales receipt via an electronic image, the user may similarly respond indicating that the signature does not appear to be that of the user. In this manner, the user can contribute his or her own comments about the on-going dispute resolution process. Thus, in addition to obtaining comments and documentation from the merchant, an auditor can also obtain information from the user. It is likely that in some instances, the user will recall that a disputed charge was actually a valid charge made by the user. Oftentimes, the formal name provided in a billing statement is a trade name rather than the name under which the business operates. Therefore, some transactions will not readily be recalled by the user without knowledge of the name under which the merchant operates with the consuming public. At any rate, at a later point in time, after disputing a charge, the user may come to the conclusion that the dispute is in error. Therefore, the user will desire to withdraw the disputed charge. A network system is advantageous in that it allows immediate cessation of the disputed charge. In a system which requires submission of documents via the postal service, the delay in receiving the documentation can cause additional work to be performed by the processing center and disruption of the merchant in obtaining supporting documentation. Thus, by providing an immediate manner of withdrawing a disputed charge, the present embodiment of the invention greatly facilitates and adds efficiency to the dispute resolution process. Thus, block 312 shows that a user interface can be provided to allow the user to withdraw the dispute of the credit charge on-line.

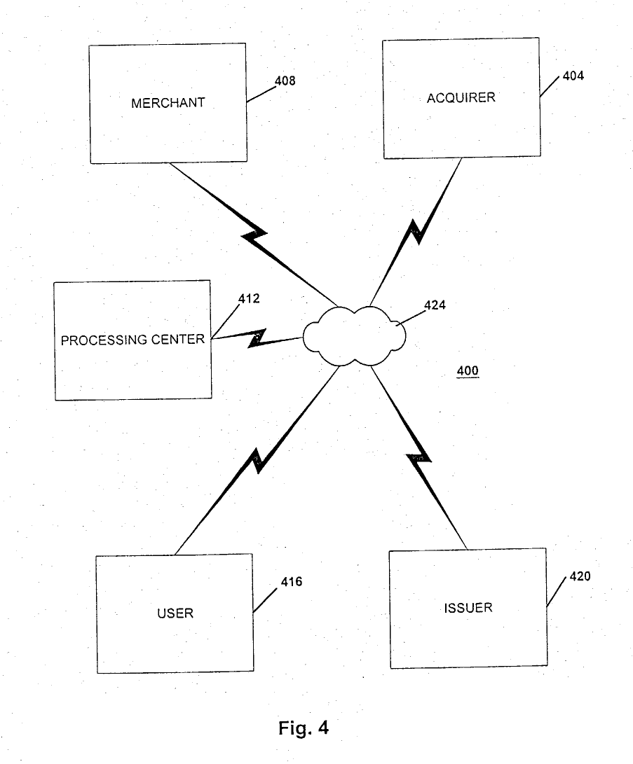

FIG. 4 illustrates a network system for implementing methods discussed in FIGS. 1-3. Namely, FIG. 4 illustrates a system 400 which is comprised of a merchant 408 and user 416. The merchant and user can conduct transactions via a network, such as the internet, or through a physical point of sale. The merchant is supported by an acquirer 404, such as an acquiring bank. Similarly, the user is supported by an issuer 420, such as an issuing bank which issues the credit card to the user. The issuer and acquirer settle disputes via a processing center 412. The processing center is responsible for obtaining data from the user, issuer, merchant, and acquirer. An auditor at the processing center is thus able to audit a disputed charge and determine whether the charge was properly made to the user's account. FIG. 4 illustrates a network 424. Such a network could be implemented via a private network or via an open network such as the internet.

FIG. 5 illustrates one example of a user interface. Namely FIG. 5 shows an example of a user's own computer 500. The user interface provided shows a billing statement 504 and an icon 508 inquiring whether the user desires to dispute the charge on the billing statement. The user then highlights a charge on the billing statement and selects “yes” to submit a chargeback request to the user's issuing bank. The user's issuing bank can then forward the chargeback request to the processing center or acquiring bank.

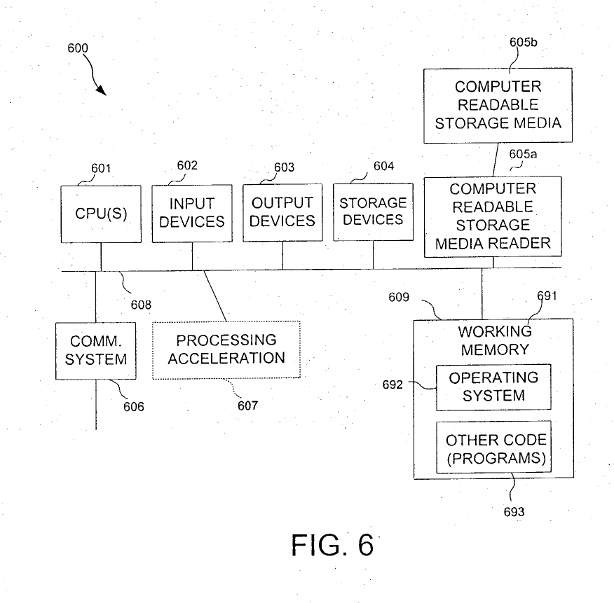

FIG. 6 illustrates a system for implementing the computer shown in FIG. 5 as well as the network devices in FIG. 4, namely user 416, issuer 420, processing center 412, merchant 408 and acquirer 404. FIG. 6 broadly illustrates how individual system 400 elements can be implemented in a separated or more integrated manner within various, generally similarly configured processing systems. System 600 is shown comprised of hardware elements that are electrically coupled via bus 608, including a processor 601, input device 602, output device 603, storage device 604, computer-readable storage media reader 605a, communications system 606 processing acceleration (e.g., DSP or special-purpose processors) 607 and memory 609. Computer-readable storage media reader 605a is further connected to computer-readable storage media 605b, the combination comprehensively representing remote, local, fixed and/or removable storage devices plus storage media, memory, etc. for temporarily and/or more permanently containing computer-readable information, which can include storage device 604, memory 609 and/or any other such accessible system 600 resource. System 600 also comprises software elements (shown as being currently located within working memory 691) including an operating system 692 and other code 693, such as programs, applets, data and the like.

System 600 is desirable as an implementation alternative largely due to its extensive flexibility and configurability. Thus, for example, a single architecture might be utilized to implement one or more servers' that can be further configured in accordance with currently desirable protocols, protocol variations, extensions, etc. However, it will be apparent to those skilled in the art that substantial variations may well be utilized in accordance with more specific application requirements. Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) and certainly not all system 600 components will be required in all cases.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents.

It is thought that the apparatuses and methods of the embodiments of the present invention and many of its attendant advantages will be understood from this specification and it will be apparent that various changes may be made in the form, construction, and arrangement of the parts thereof without departing from the spirit and scope of the invention or sacrificing all of its material advantages, the form herein before described being merely exemplary embodiments thereof.

What is claimed is:

1. A method of disputing a credit charge, said method comprising:
providing a user interface for use by a user in disputing a credit charge charged to an account of said user;
providing access to said interface by said user via a network connection;
receiving an input via said user interface from said user disputing said credit charge;
initiating a chargeback of said disputed credit charge.

2. The method as described in claim 1 and further comprising:
forwarding a chargeback request to a chargeback processing service.

3. The method as described in claim 1 and further comprising:
providing a user interface to allow said user to check on the status of said chargeback.

4. The method as described in claim 3 and further comprising:
conveying to the user an electronic image of a document supporting the application of the disputed charge to the account of the user.

5. The method as described in claim 3 and further comprising:
providing a user interface to allow said user to respond to presentation of said document supporting said application of said disputed charge to said account of said user.

6. The method as described in claim 1 and further comprising:
providing a user interface to allow said user to withdraw said dispute of said credit charge.

7. The method as described in claim 1 and further comprising:
recalculating a balance due on said account of the user, comprising subtracting the cost of the disputed charge from the current balance due on said account of said user.

8. The method as described in claim 1 and further comprising:
displaying to a user conditions for initiating a chargeback.

9. The method as described in claim 1 and further comprising:
determining whether it is too late to initiate said chargeback.

10. A method of disputing a credit charge, said method comprising:
providing a billing statement comprising a list of transactions charged to a credit account of a user;
storing said billing statement in a database accessible via a network;
providing access to said database by said user;
in response to said user accessing said database, transmitting said billing statement for viewing by said user;
providing a user interface to allow said user to dispute at least one of said transactions charged to said credit account of said user;
in response to an input by said user via said user interface, initiating a chargeback of said at least one disputed transaction.

11. The method as described in claim 10 and further comprising:
forwarding a chargeback request to a chargeback processing service.

12. The method as described in claim 10 and further comprising:
providing a user interface to allow said user to check on the status of said chargeback.

13. The method as described in claim 10 and further comprising:
conveying to said user an electronic image of a document supporting the application of the disputed charge to the account of the user.

14. The method as described in claim 10 and further comprising:
providing a user interface to allow said user to respond to presentation of said document supporting said application of said disputed charge to said account of said user.

15. The method as described in claim 10 and further comprising:
providing a user interface to allow said user to withdraw said dispute of said credit charge.

16. The method as described in claim 10 and further comprising:
recalculating a balance due on said account of the user, comprising subtracting the cost of the disputed charge from the current balance due on said account of said user.

17. The method as described in claim 10 and further comprising:
displaying to a user conditions for initiating a chargeback.

18. The method as described in claim 10 and further comprising:
determining whether it is too late to initiate said chargeback.

19. The method as described in claim 10 and further comprising:
mailing said bill to said user.

20. The method as described in claim 10 and further comprising:
mailing a revised bill to said user.

21. An article of manufacture comprising:
a computer usable medium having computer readable program code embodied therein for providing a user interface for initiating a chargeback, the computer readable program code means in said article of manufacture comprising:
computer readable program code for causing a computer to provide a user interface for use by a user in disputing a credit charge charged to an account of said user;
computer readable program code for causing the computer to provide access to said interface by said user via a network connection;
computer readable program code for causing the computer to initiate a chargeback of said disputed credit charge.

22. The article of manufacture as described in claim 21 and further comprising:
computer readable program code for causing the computer to forward a chargeback request to a chargeback processing service.

23. The article of manufacture as described in claim 21 and further comprising:
computer readable program code for providing a user interface to allow said user to check on the status of said chargeback.

24. The article of manufacture as described in claim 21 and further comprising:
computer readable program code for conveying to said user an electronic image of a document supporting the application of the disputed charge to the account of the user.

25. The article of manufacture as described in claim 21 and further comprising:
computer readable program code for providing a user interface to allow said user to respond to presentation of said document supporting said application of said disputed charge to said account of said user.

26. The article of manufacture as described in claim 21 and further comprising:
computer readable program code for providing a user interface to allow said user to withdraw said dispute of said credit charge

27. The article of manufacture as described in claim 21 and further comprising:
computer readable program code for recalculating a balance due on said account of the user, comprising subtracting the cost of the disputed charge from the current balance due on said account of said user.

28. The article of manufacture as described in claim 21 and further comprising:
computer readable program code for displaying to a user conditions for initiating a chargeback.

29. The article of manufacture as described in claim 21 and further comprising:
computer readable program code for determining whether it is too late to initiate said chargeback.
